(19) United States
(12) Patent Application Publication
(10) Pub. No.: US 2026/0220871 A1
(43) Pub. Date: Jul. 30, 2026

(54) PROJECTION MAPPING USING DYNAMIC BLEND MAPS

(71) Applicant: DISNEY ENTERPRISES, INC., Burbank, CA (US)

(72) Inventors: Prutsdom JIARATHANAKUL, Glendale, CA (US); David Robert Wyatt ROSE, Glendale, CA (US)

(21) Appl. No.: 19/330,619

(22) Filed: Sep. 16, 2025

Related U.S. Application Data
(60) Provisional application No. 63/750,721, filed on Jan. 28, 2025.

(51) Int. Cl. G06T 15/04; G06T 3/08; G06T 5/30; G06T 5/70; G06T 15/00; G06T 15/50; G06T 15/60; H04N 9/31

(52) U.S. Cl. CPC G06T 15/04; G06T 3/08; G06T 5/30; G06T 5/70; G06T 15/005; G06T 15/503; G06T 15/60; H04N 9/3147; H04N 9/3182; H04N 9/3185; G06T 2215/12

(57) ABSTRACT

A computer-implemented technique for projecting light includes generating, based on a pose of an object within the scene, projector calibration data associated with one or more projectors, and scene geometry data associated with the scene, one or more blend maps using a graphics engine, generating, based on the one or more blend maps and media to be projected via the one or more projectors, one or more blended projections, and causing the one or more projectors to project light upon the object based on the one or more blended projections.

### CROSS-REFERENCE TO RELATED APPLICATIONS

This application claims priority benefit of the United States Provisional Patent Application titled, “TECHNIQUES FOR PROJECTION MAPPING USING DYNAMIC BLEND MAPS,” filed on Jan. 28, 2025, and having Ser. No. 63/750,721. The subject matter of this related application is hereby incorporated herein by reference.

### BACKGROUND

### Field of the Various Embodiments

The various embodiments relate generally to computer graphics, projection mapping, and real-time rendering, and, more specifically, to projection mapping using dynamic blend maps.

### Description of the Related Art

Projection mapping is a technique in which digital imagery is projected onto physical objects using one or more projectors in a way that conforms to the shape and surface features of an object. In projection mapping, blend maps, which are grayscale images applied to the output of each projector, are used to generate a uniform level of perceived brightness on a target object. Blend maps achieve the uniform level of brightness by compensating for the effect of the incident angle of projector light on the surface, as well as adjusting for regions where multiple projectors overlap. For example, a building façade can be illuminated with dynamic visuals that align with the architectural details to create immersive light shows. As another example, projection mapping can be used in entertainment venues (e.g., theme parks, theaters, interactive art installations, etc.) to transform physical props into animated storytelling elements. Industrial applications can also project assembly guides or safety indicators directly onto complex machinery to assist operators.

One conventional approach for projection mapping is to precompute blend maps and projection content in advance, including all brightness adjustments and alignment parameters. For example, designers can manually calibrate each projector to the target object, measure the surface geometry, and generate static blend maps that compensate for incident angles and projector overlaps. The calibration process could include capturing detailed 3D scans of the projection surface, defining projection regions for each projector, and applying feathering techniques to smooth transitions between overlapping areas. The resulting blend maps and projection imagery are then stored and applied during playback to generate a consistent projection effect.

One drawback of conventional approaches for projection mapping is that the static blend maps and projection content typically cannot be changed in response to real-time changes in the physical environment (e.g., a scene). Instead, once blend maps are precomputed and projection imagery is prepared, the resulting brightness compensation and alignment remain fixed, regardless of new developments, such as object movement, deformation, dynamic lighting conditions, and/or the like. For example, a projection on a stage set could not be automatically adjusted when a prop is moved or rotated during a performance. As another example, in an interactive art installation, a projection-mapped sculpture could remain illuminated according to an original calibration, even when viewers physically move or interact with the sculpture in ways that alter the projection surface.

As the foregoing illustrates, what is needed in the art are more effective techniques for projection mapping.

### SUMMARY

One embodiment of the present disclosure sets forth a computer-implemented method for projecting light. The method includes generating, based on a pose of an object within the scene, projector calibration data associated with one or more projectors, and scene geometry data associated with the scene, one or more blend maps using a graphics engine. The method further includes generating, based on the one or more blend maps and media to be projected via the one or more projectors, one or more blended projections. The method also includes causing the one or more projectors to project light upon the object based on the one or more blended projections.

Other embodiments of the present disclosure include, without limitation, one or more computer-readable media including instructions for performing one or more aspects of the disclosed techniques as well as a computing device for performing one or more aspects of the disclosed techniques.

At least one technical advantage of the disclosed techniques relative to the prior art is that the disclosed techniques dynamically calculate blend maps and apply the blend maps to projected content in real time based on continuously updated scene information. Unlike conventional approaches that are static, the disclosed techniques recalculate per-projector contribution maps using live geometric, shadow, and lighting data from the projection surface of the object. As the scene changes, such as when an object moves, deforms, or experiences varying illumination, the expanded shadow maps, cosine maps, projector contributions, and resulting blend maps are regenerated to reflect the new conditions. The regenerations can be executed as shader passes on a graphics processing unit (GPU), which enables interactive frame rates in real time, which enables the projection to maintain accurate brightness compensation between projectors, and correct shadow handling even during motion or interaction. These technical advantages represent one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

The patent or application file contains at least one drawing executed in color. Copies of this patent or patent application publication with color drawing(s) will be provided by the Office upon request and payment of the necessary fee.

FIG. 1 illustrates a block diagram of a computer-based system configured to implement one or more aspects of the various embodiments;

FIG. 2 is a more detailed illustration of the computing device of FIG. 1, according to various embodiments;

FIG. 3 is a more detailed illustration of the projection application of FIG. 1, according to various embodiments;

FIG. 4 illustrates how the projection application of FIG. 1 generates blend maps, according to various embodiments;

FIG. 5 illustrates a comparative visual example showing projection results before and after applying the disclosed techniques, according to various embodiments; and

FIG. 6 is a flow diagram of method steps for generating blended projections, according to various embodiments.

### DETAILED DESCRIPTION

In the following description, numerous specific details are set forth to provide a more thorough understanding of the various embodiments. However, it will be apparent to one of skill in the art that the inventive concepts can be practiced without one or more of these specific details.

### System Overview

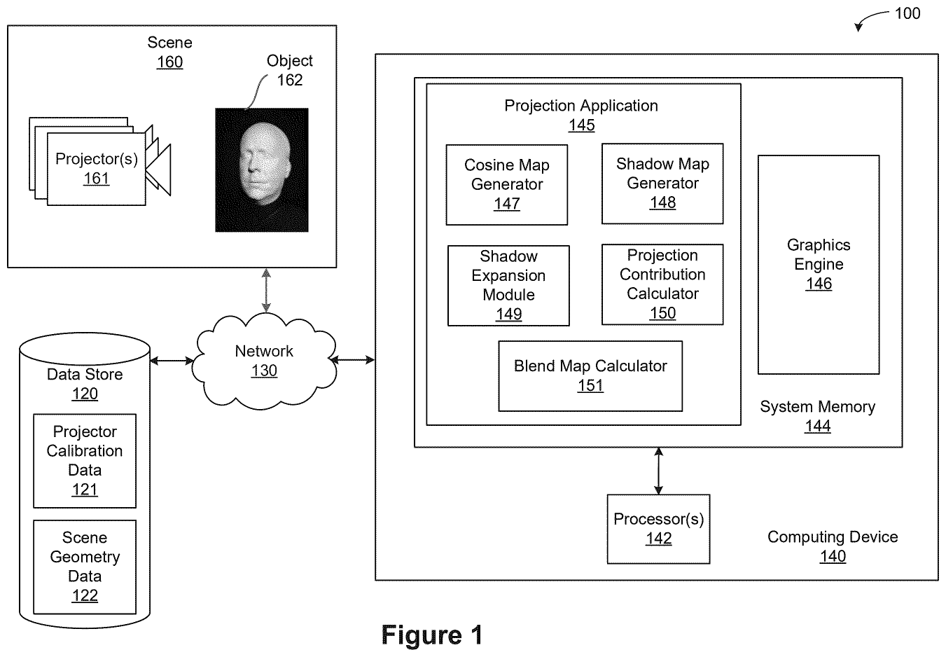

FIG. 1 illustrates a block diagram of a computer-based system 100 configured to implement one or more aspects of at least one embodiment. As shown, system 100 includes, without limitation, a scene 160, a data store 120, and a computing device 140 in communication over a network 130, which can include a wide area network (WAN) such as the Internet, a local area network (LAN), a cellular network, and/or any other suitable network or networks. Computing device 140 includes, without limitation, processor(s) 142 and a system memory 144. System memory 144 includes, without limitation, a projection application 145 and a graphics engine 146. Projection application 145 includes, without limitation, a cosine map generator 147, a shadow map generator 148, a shadow expansion module 149, a projection contribution calculator 150, and a blend map calculator 151. Although shown as being included in projection application 145 for illustrative purposes, functionality of cosine map generator 147, shadow map generator 148, shadow expansion module 149, projection contribution calculator 150, and/or blend map calculator 151 can be implemented elsewhere, such as inside graphics engine 146, in some embodiments. Scene 160 includes, without limitation, one or more projector(s) 161 and an object 162.

As shown, projection application 145 and graphics engine 146 execute on one or more processors 142 of computing device 140 and are stored in a system memory 144 of computing device 140. Processor(s) 142 receive user input from input devices, such as a keyboard, a mouse, a trackpad, a touch screen, or a microphone. In operation, processor(s) 142 may include one or more primary processors of computing device 140, controlling and coordinating operations of other system components. In particular, processor(s) 142 can issue commands that control the operation of one or more graphics processing units (GPUs) (not shown) and/or other parallel processing circuitry (e.g., parallel processing units, deep learning accelerators, etc.) that incorporates circuitry optimized for graphics and video processing, including, for example, video output circuitry. The GPU(s) can deliver pixels to a display device that can be any conventional cathode ray tube, liquid crystal display, light-emitting diode display, and/or the like.

System memory 144 of computing device 140 stores content, such as software applications and data, for use by processor(s) 142 and the GPU(s) and/or other processing units. System memory 144 can be any type of memory capable of storing data and software applications, such as a random-access memory (RAM), a read-only memory (ROM), an erasable programmable read-only memory (EPROM or Flash ROM), or any suitable combination of the foregoing. In some embodiments, a storage (not shown) can supplement or replace system memory 144. The storage can include any number and type of external memories that are accessible to processor(s) 142 and/or the GPU. For example, and without limitation, the storage can include a Secure Digital Card, an external Flash memory, a portable compact disc read-only memory (CD-ROM), an optical storage device, a magnetic storage device, and/or any suitable combination of the foregoing.

Computing device 140 shown herein is for illustrative purposes only, and variations and modifications are possible without departing from the scope of the present disclosure. For example, the number of processors 142, the number of GPUs and/or other processing unit types, the number of system memories 144, and/or the number of applications included in system memory 144 can be modified as desired. Further, the connection topology between the various units in FIG. 1 can be modified as desired. In some embodiments, any combination of processor(s) 142, system memory 144, and/or GPU(s) can be included in and/or replaced with any type of virtual computing system, distributed computing system, and/or cloud computing environment, such as a public, private, or a hybrid cloud system.

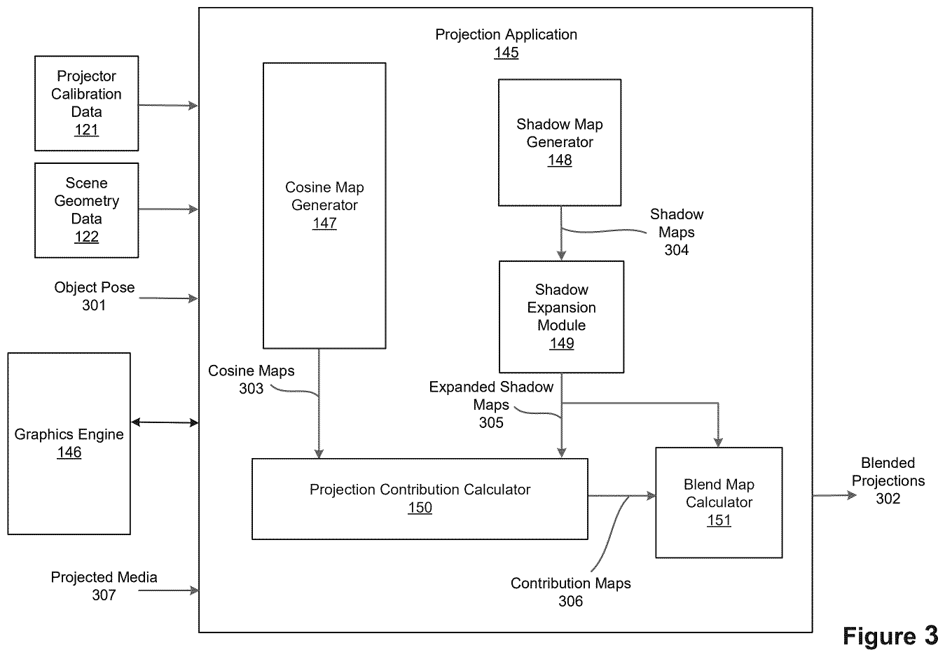

Projection application 145 is an application that uses graphics engine 146 to process a current pose of object 162, projector calibration data 121, a projected media, and scene geometry data 122 and generate one or more blended projections for projectors(s) 161 (referred to herein collectively as projectors 161 and individually as a projector 161). Projector calibration data 121 and scene geometry data 122 can be stored in datastore 120 or elsewhere (e.g., system memory 144). Projector calibration data 121 includes intrinsic parameters of each projector 161, such as a focal length, a principal point, lens distortion coefficients, resolution, and/or a pixel aspect ratio, as well as extrinsic parameters, such as the position and orientation of each projector 161 relative to a world coordinate system or object 162 being projected upon. Projector calibration data 121 further includes per-pixel warp or correction maps to account for optical distortions or misalignments, as well as timing parameters for synchronization with other projectors 161. Scene geometry data 122 includes the spatial arrangement, scale, and shape descriptors of object 162 and the surrounding environment included in scene 160, such as vertex coordinates, polygon connectivity, point cloud data, and/or the like. Scene geometry data 122 also includes surface normals, material reflectance properties, and other attributes that assist in simulating light interaction and occlusion. In some embodiments, scene geometry data 122 is dynamically updated to reflect real-time changes in the position, orientation, and/or deformation of object 162. In some embodiments, scene geometry data 122 includes a 3D representation of object 162 and/or an environment included in scene 160 to be projected upon, which can be expressed as a polygon mesh, point cloud, or other surface parametrization, such as a UV surface representation. In some embodiments, the blended projections are transmitted to projectors 161 via a display cable or other display transport technology rather than over network 130. Projection application 145 is described in greater detail in conjunction with FIGS. 3-5.

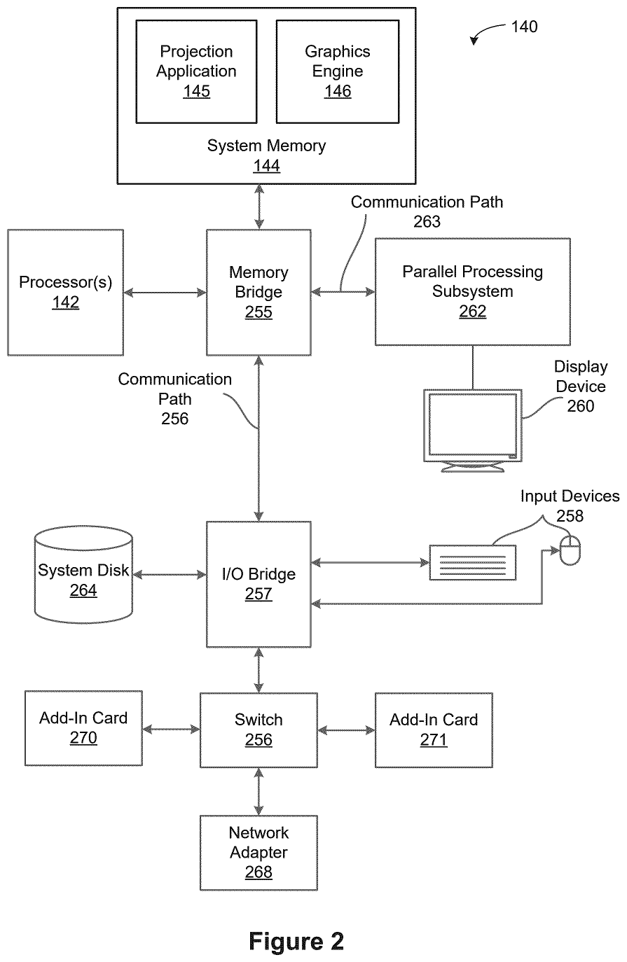

FIG. 2 is a more detailed illustration of computing device 140 of FIG. 1, according to various embodiments. Computing device 140 may include any type of computing system, including, without limitation, a server machine, a server platform, a desktop machine, a laptop machine, a hand-held/mobile device, a digital kiosk, an in-vehicle infotainment system, and/or a wearable device. In some embodiments, computing device 140 is a server machine operating in a data center or a cloud computing environment that provides scalable computing resources as a service over a network.

In various embodiments, computing device 140 includes, without limitation, processor(s) 142 and system memory 144 coupled to a parallel processing subsystem 262 via a memory bridge 255 and a communication path 263. Memory bridge 255 is further coupled to an I/O bridge 257 via a communication path 256, and I/O bridge 257 is, in turn, coupled to a switch 256.

In some embodiments, I/O bridge 257 is configured to receive user input information from optional input devices 258, such as a keyboard, mouse, touch screen, sensors (e.g., camera, microphone, etc.), and/or the like, and forward the input information to processor(s) 142 for processing. In some embodiments, computing device 140 may be a server machine in a cloud computing environment. In such embodiments, computing device 140 may not include input devices 258, but may receive equivalent input information by receiving commands (e.g., responsive to one or more inputs from a remote computing device) in the form of messages transmitted over a network and received via network adapter 268. In some embodiments, switch 256 is configured to provide connections between I/O bridge 257 and other components of computing device 140, such as a network adapter 268 and various add-in cards 270 and 271.

In some embodiments, I/O bridge 257 is coupled to a system disk 264 that may be configured to store content and applications and data for use by processor(s) 142 and parallel processing subsystem 262. In some embodiments, system disk 264 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high-definition DVD), or other magnetic, optical, or solid-state storage devices. In various embodiments, other components, such as universal serial bus or other port connections, compact disc drives, digital versatile disc drives, film recording devices, and the like, may be connected to I/O bridge 257 as well.

In various embodiments, memory bridge 255 may be a Northbridge chip, and I/O bridge 257 may be a Southbridge chip. In addition, communication paths 256 and 263, as well as other communication paths within computing device 140, may be implemented using any technically suitable protocols, including, without limitation, AGP (Accelerated Graphics Port), HyperTransport, or any other bus or point-to-point communication protocol known in the art.

In some embodiments, parallel processing subsystem 262 comprises a graphics subsystem that delivers pixels to an optional display device 260 that may be any conventional cathode ray tube, liquid crystal display, light-emitting diode display, and/or the like. In such embodiments, parallel processing subsystem 262 may incorporate circuitry optimized for graphics and video processing, including, for example, video output circuitry. Such circuitry may be incorporated across one or more PPUs, also referred to herein as parallel processors, included within parallel processing subsystem 262.

In some embodiments, parallel processing subsystem 262 incorporates circuitry optimized (e.g., that undergoes optimization) for general purpose and/or compute processing. Again, such circuitry may be incorporated across one or more PPUs included within parallel processing subsystem 262 that are configured to perform such general purpose and/or compute operations. In yet other embodiments, the one or more PPUs included within parallel processing subsystem 262 may be configured to perform graphics processing, general purpose processing, and/or compute processing operations. System memory 144 includes at least one device driver configured to manage the processing operations of the one or more PPUs within parallel processing subsystem 262. In addition, system memory 144 includes projection application 145 and graphics engine 146. Although described herein primarily with respect to projection application 145 and graphics engine 146, techniques disclosed herein can also be implemented, either entirely or in part, in other software and/or hardware, such as in parallel processing subsystem 262.

In various embodiments, parallel processing subsystem 262 may be integrated with one or more of the other elements of FIG. 2 to form a single system. For example, parallel processing subsystem 262 may be integrated with processor(s) 142 and other connection circuitry on a single chip to form a SoC.

In some embodiments, processor(s) 142 includes the primary processor of computing device 140, controlling and coordinating operations of other system components. In some embodiments, processor(s) 142 issue commands that control the operation of PPUs. In some embodiments, communication path 263 is a PCI Express link, in which dedicated lanes are allocated to each PPU. Other communication paths may also be used. The PPU advantageously implements a highly parallel processing architecture, and the PPU may be provided with any amount of local parallel processing memory (PP memory).

It will be appreciated that the system shown herein is illustrative and that variations and modifications are possible. The connection topology, including the number and arrangement of bridges, the number of processor(s) 142, and the number of parallel processing subsystems 262, may be modified as desired. For example, in some embodiments, system memory 144 could be connected to processor(s) 142 directly rather than through memory bridge 255, and other devices may communicate with system memory 144 via memory bridge 255 and processor(s) 142. In other embodiments, parallel processing subsystem 262 may be connected to I/O bridge 257 or directly to processor(s) 142, rather than to memory bridge 255. In still other embodiments, I/O bridge 257 and memory bridge 255 may be integrated into a single chip instead of existing as one or more discrete devices. In certain embodiments, one or more components shown in FIG. 2 may not be present. For example, switch 256 could be eliminated, and network adapter 268 and add-in cards 270, 271 would connect directly to I/O bridge 257. Lastly, in certain embodiments, one or more components shown in FIG. 2 may be implemented as virtualized resources in a virtual computing environment, such as a cloud computing environment. For example, parallel processing subsystem 262 may be implemented as a virtualized parallel processing subsystem in at least one embodiment. As a specific example, parallel processing subsystem 262 may be implemented as virtual graphics processing unit(s) (vGPU(s)) that render graphics on a virtual machine(s) (VM(s)) executing on server machine(s) whose GPU(s) and other physical resources are shared across one or more VMs.

### Generating a Blended Projection Based on Object Pose, Projector Calibration Data, and Scene Geometry Data

FIG. 3 is a more detailed illustration of projection application 145, according to various embodiments. As shown, projection application 145 includes, without limitation, cosine map generator 147, shadow map generator 148, shadow expansion module 149, projection contribution calculator 150, and blend map calculator 151. In operation, cosine map generator 147 uses graphics engine 146 to process object pose 301, projector calibration data 121, and scene geometry data 122 to generate one or more cosine maps 303. Shadow map generator 148 uses graphics engine 146 to process object pose 301, projector calibration data 121, and scene geometry data 122 and generate one or more shadow maps 304. Shadow expansion module 149 processes shadow maps 304 and generates one or more expanded shadow maps 305. Projection contribution calculator 150 processes cosine maps 303 and expanded shadow maps 305 and generates one or more contribution maps 306. Blend map calculator 151 processes expanded shadow maps 305 and contribution maps 306 and calculates one or more blend maps. Projection application 145 multiplies the blend maps and projected media 307 to generate blended projections 302.

In some embodiments, cosine map generator 147 uses Lambert's Cosine Law, which states that the perceived brightness on a surface is proportional to the cosine of the angle between the incident light direction and the surface normal, to generate cosine maps 303. According to Lambert's Cosine Law, the surfaces of object 162 directly facing each projector 161 appear brighter, while surfaces angled away appear dimmer. In some embodiments, cosine map generator 147 generates cosine compensation maps (e.g., cosine maps 303) that counteract the brightness variation to achieve uniform illumination across the projection surface of object 162. In some embodiments, cosine map generator 147 uses a custom shader included in graphics engine 146 that outputs, for each projector 161, a value between 0 and 1 of the cosine light value included in cosine maps 303 from the projector 161. The cosine light values are written out to unique channels, for example, red and green, respectively. In some examples, the custom shader renders the image in UV space, which requires scene 160 or a model of scene 160 to have properly defined UVs with minimal seams and no overlaps. In some embodiments, cosine map generator 147 generates cosine maps 303 using graphics engine 146 that renders the 3D scene geometry included in scene geometry data 122 from the perspective of each projector 161, with each projector 161 represented as a light source. In some embodiments, graphics engine 146 uses a basic Lambertian shading material with diffuse color set to pure white (1,1,1), resulting in a rendered image in which each pixel encodes the cosine light value included in cosine maps 303 for the corresponding surface point of object 162. The rendered image is then inverted (1/x) to generate cosine compensation maps that cancel the cosine effect. In some embodiments, cosine map generator 147 uses a custom shader that directly outputs the inverse cosine light values (e.g., cosine maps 303) in a single rendering pass, thereby avoiding the need for multiple passes and improving computational efficiency. In some embodiments, cosine map generator 147 generates cosine maps 303 in UV space, enabling a single set of lighting and shadow computations to be reused for N projectors 161, rather than performing N×N per-view computations. In some embodiments where a UV space representation is unavailable, cosine map generator 147 uses a “neutral” view space to provide cosine light values for all projectors 161 from a single reference viewpoint, followed by reprojection into individual view spaces of projectors 161. In some embodiments, cosine map generator 147 uses any shared common space upon which lighting and shadow computations can be performed consistently for all projectors 161. In some embodiments, the shared common space includes, without limitation, a UV coordinate space, a neutral view space, or another representation that enables reuse of a single set of lighting computations across projectors 161. The shared common space provides a unified domain in which cosine light values can be generated once and then distributed or reprojected into the respective projector view spaces, thereby improving computational efficiency.

Shadow map generator 148 is a module of projection application 145 that uses graphics engine 146 to process object pose 301, projector calibration data 121, and scene geometry data 122 and generate one or more shadow maps 304. A shadow map 304 is a per-pixel representation indicating whether a given point on the projection surface of object 162 is directly visible from the light position of a projector 161 or occluded by another object or surface geometry included in scene 160. In some embodiments, shadow maps 304 include a binary value of 0 or 1 for every pixel per projector 161. In some embodiments, each shadow map 304 includes occlusion information in a depth-buffer format or equivalent representation, where pixels corresponding to visible points store a value indicating direct illumination, and pixels corresponding to occluded points store a value indicating shadow. In some embodiments, shadow map generator 148 uses the same rendering pass as cosine map generator 147, outputting the hard shadow map values included in shadow maps 304 to a separate channel (e.g., green or red). A “hard” shadow refers to a binary shadow representation in which each pixel is assigned a value corresponding to either direct illumination or complete occlusion, without intermediate values for partial shadowing or penumbra effects. In some embodiments, shadow map generator 148 uses graphics engine 146 to render scene 160 from the perspective of each projector 161 using depth rendering techniques to capture the distance from each projector 161 to the nearest visible surface point of object 162 generating depth data. During subsequent shading or blending computations, a given surface point is compared against the depth data to determine whether the point lies in direct line of sight of each projector 161 or falls within an occlusion region in order to generate a shadow map 304. The resulting shadow map 304 can be stored in a floating-point or integer texture format to allow high-resolution shadow determination for intricate geometry of object 162. In some embodiments, shadow map generator 148 operates in UV space to generate shadow maps 304 for all projectors 161 from a single precomputed geometric representation, reducing computational load by avoiding redundant per-view passes. Whenever a UV space representation of object 162 is not available, shadow map generator 148 uses a neutral view space to generate shadow information included in shadow maps 304, followed by reprojection into individual view spaces of projectors 161. In some embodiments, shadow map generator 148 uses any shared common space upon which shadow computations can be performed consistently for all projectors 161. The shared common space includes, without limitation, a UV coordinate space, a neutral view space, or another representation that enables generation of shadow values once and subsequent reprojection into the view space of each projector 161.

Shadow expansion module 149 is a module of projection application 145 that processes shadow maps 304 and generates expanded shadow maps 305. In some embodiments, to generate expanded shadow maps 305, shadow expansion module 149 isolates shadow values included in shadow maps 304 and applies a sequence of image processing operations, such as dilation and blurring, to increase the spatial extent of shadow regions while maintaining smooth transitions at the boundaries. Expanding shadow maps 304 can mitigate sharp edges in the projection results at the boundaries of cast shadow regions where light cannot reach. In that regard, projection application 145 intentionally does not project into shadowed regions to avoid causing the hard cast shadow in the first place by virtually calculating where the hard shadows would be created by the projector, artificially expanding out such shadow regions, and giving the expanded shadow regions a smooth feathered edge. Accordingly, projection application 145 projects “virtual shadows” into the physical hard cast shadows to hide the cast shadows and expands the cast shadows larger to produce smooth edges, which is much easier to blend and compensate for by increasing the brightness in such a region from another projector. In some embodiments, shadow expansion module 149 performs the expansion in UV space permitting that the operation occurs in a 2D parameterization of the surface of object 162, where the expansion follows surface topology without introducing discontinuities. In UV-based processing, shadow expansion module 149 enlarges shadow regions uniformly, generating expanded shadow areas with soft, feathered edges that facilitate smooth blending when multiple projectors 161 illuminate overlapping areas of the projection surface of object 162.

Projection contribution calculator 150 is a module of projection application 145 that processes cosine maps 303 and expanded shadow maps 305 and calculates contribution maps 306. In some embodiments, projection contribution calculator 150 uses expanded shadow maps 305 to attenuate or nullify cosine light values included in cosine maps 303 in pixels that are shadowed relative to a given projector 161. For each pixel, projection contribution calculator 150 calculates an illumination mask as 1−sᵢ, where sᵢ is the corresponding value from the expanded shadow map 305 for projector 161 i (e.g., 0=fully illuminated, 1=fully shadowed). Projection contribution calculator 150 then multiplies the cosine light values by the illumination mask to generate an unshadowed cosine light value pᵢ for every pixel. The masking ensures that regions occluded from the light of a projector 161 do not contribute to the brightness calculation. In some embodiments, projection contribution calculator 150 uses an adjustment function, for example, expressed as:

$${p}_{0} \cdot f ( {p}_{0} , {p}_{1} , … , {p}_{n} ) + {p}_{1} \cdot f ( {p}_{1} , {p}_{0} , {p}_{2} , … , {p}_{n} ) + … + {p}_{n} \cdot f ( {p}_{n} , {p}_{0} , … , {p}_{n - 1} ) = 1 , \qquad ( Equation 1 )$$

where f(·) is the adjustment function and each pᵢ has already been masked by the corresponding expanded shadow map 305. For example, in some embodiments, projection contribution calculator 150 uses an equal distribution adjustment function, for example, expressed as:

$$f ( {p}_{0} , {p}_{1} , … , {p}_{n} ) = \frac{1}{{p}_{0} + {p}_{1} + ⋯ + {p}_{n}} . \qquad ( Equation 2 A )$$

As another example, in some embodiments, projection contribution calculator 150 applies an unequal prioritized distribution, for example, as given by

$$f ( {p}_{0} , {p}_{1} , … , {p}_{n} ) = \{ \begin{matrix}\frac{1}{{p}_{0}} , & {p}_{0} > {p}_{1} , … , {p}_{n} \\ 0 , & otherwise\end{matrix} . \qquad ( Equation 2 B )$$

In some embodiments, projection contribution calculator 150 uses any adjustment function that fulfills the requirement given by Equation 1. In some embodiments, projection contribution calculator 150 further applies value-based feathering between unshadowed contributions from various projectors 161 to smooth transitions where the dominant projector 161 changes. For example, projection contribution calculator 150 can use basic linear feathering between two unshadowed projector contributions 161 p₀ and p₁ as given by:

$$f ( {p}_{0} , {p}_{1} ) = {clamp}_{0 , 1} ( \frac{{p}_{0} - {p}_{1} + \frac{C}{2}}{C} ) , \qquad ( Equation 3 )$$

where C is a feathering constant defining the blending width. The blending width refers to the transition zone, measured in pixel intensity values or normalized units, over which the contributions of two or more projectors are smoothly interpolated. A larger blending width produces a more gradual transition between projectors 161, reducing visible seams, while a smaller blending width produces a sharper transition.

Blend map calculator 151 is a module of projection application 145 that processes expanded shadow maps 305 and contribution maps 306 and generates blend maps. The expanded shadow maps 305 preserve shadow darkness values necessary to conceal physical shadows, while the contribution maps 306 determine projector 161 brightness adjustments for uniform illumination across the projection surface of object 162. In some embodiments, blend map calculator 151 applies a blurring operation to light value components included in contribution maps 306 to mitigate the effects of real-world imperfections and misalignments, while maintaining sharpness in shadow components included in expanded shadow maps 305. In some embodiments, blend map calculator 151 multiplies the light value components by the preserved shadow values to generate blend maps.

In some embodiments, projection application 145 processes the blend maps and projected media 307 and generates blended projections 302. Projected media 307 includes one or more input images, video frames, or other graphical content to be displayed on the projection surface of object 162. For each projector 161, projection application 145 applies the corresponding blend map, which encodes per-pixel intensity adjustments calculated to achieve uniform perceived brightness across the projection surface of object 162. In some embodiments, projection application 145 multiplies the blend maps with the pixel values of the projected media 307 in the image space of each projector 161 (e.g., UV space or projector-specific view space), attenuating regions that require brightness reduction and maintaining or amplifying regions that require compensation for incident angle effects or multi-projector overlap. Projection application 145 then transmits the adjusted per-projector images included in blended projections 302 to projectors 161 for synchronous output, in which each of projectors 161 projects light based on one of the adjusted per-projector images. When projected simultaneously, the combined output from all projectors 161 generates a uniformly illuminated blended projection 302 on the surface of object 162, with compensated brightness in overlap regions, corrected for incident angle variations, and masked for occluded areas.

In some embodiments, generating shadow maps 304, generating expanded shadow map 305, contribution maps 306, and generating cosine maps 303 are implemented as shader passes executed on a GPU. By leveraging the GPU rendering, the disclosed techniques can be performed at interactive frame rates, thereby allowing blend maps and blended projections 302 to be dynamically updated in response to real-time changes in scene 160.

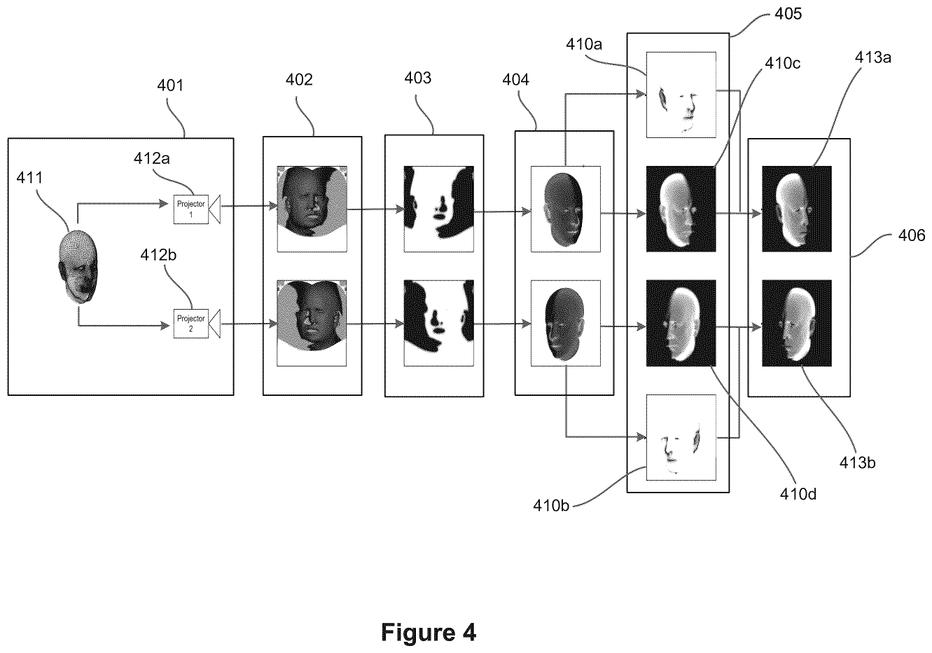

FIG. 4 illustrates how the projection application 145 generates blend maps, according to various embodiments. As shown, at phase 401, graphics engine 146 performs rendering using two virtual projectors 412a and 412b, which are virtual representations of projectors 161, and a 3D surface representation 411 of an object 162 (e.g., a head model) positioned in scene 160. Each projector 161 is calibrated relative to object 162 and has a unique perspective from which the projector will project media. At phase 402, for each virtual projector 412a and 412b, cosine map generator 147 generates a cosine map, and the cosine maps are represented by a red channel. Shadow map generator 148 generates shadow maps 304, which are represented by a green channel. At phase 403, shadow expansion module 149 processes shadow maps 304 and generates expanded shadow maps 305, which soften shadow edges to account for projection overlap and possible misalignment. Expanded shadow maps 305 appear as greyscale images where black regions are fully shadowed (mask=0) and white regions are fully illuminated (mask=1). At phase 404, projection contribution calculator 150 multiplies each virtual projector 412a and 412b's cosine map 303 by the mask derived from the corresponding expanded shadow map 305, generating unnormalized per-projector contribution maps 306. Contribution maps 306 represent the relative illumination contribution of each virtual projector 412a and 412b, with shadowed regions attenuated toward zero. At phase 405, blend map calculator 151 normalizes contribution maps 306 across all virtual projectors 412a and 412b for each pixel so that the sum equals one to ensure that in overlapping regions, each projector contributes proportionally to the unshadowed cosine light value. The output is per-projector blend maps 410a and 410b, which are grayscale weight maps controlling how much of each projected media content is visible in the final blended projections 302. In phase 406, blend maps 410a and 410b are multiplied with the corresponding projected media 410c and 410d to generate blended projection 413a for projector 412a and blended projection 413b for projector 412b, respectively.

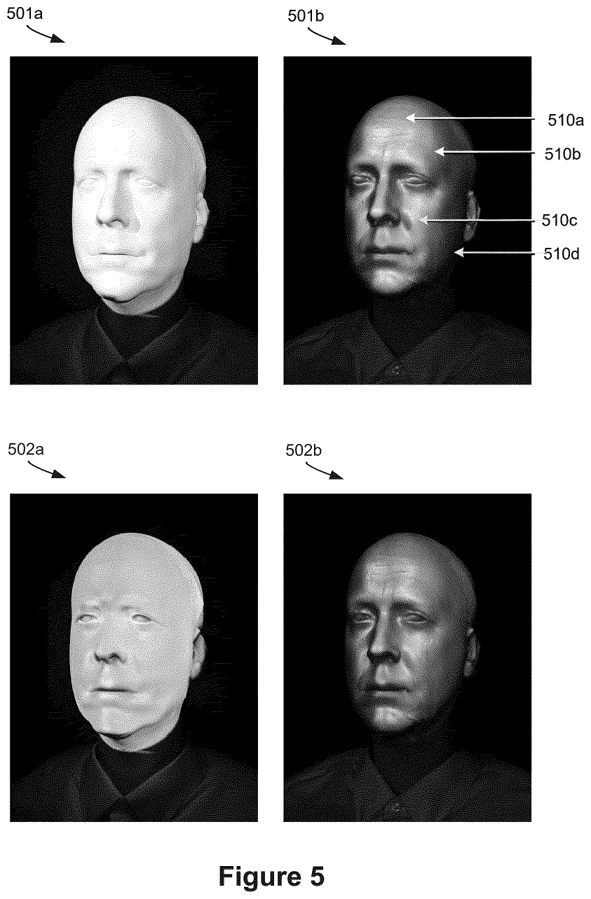

FIG. 5 illustrates a comparative visual example showing projection results before and after applying the disclosed techniques, according to various embodiments. As shown, image 501a depicts a base map upon which projection media can be applied on a 3D facial surface, without applying the disclosed techniques. The grayscale projection shown in image 501a reveals uneven brightness and shading artifacts resulting from the combined effects of projector overlap, surface geometry, and grazing angles. Image 501b shows the same surface with projected media 307 applied. Several projection quality issues are shown: (a) unnatural hotspot 510a in the middle region caused by overlapping coverage from multiple projectors, (b) visible hard edge 510b, where the coverage of a projector ends, leading to a sharp brightness transition, (c) visible hard edge 510c from cast shadows due to uncorrected shadow boundaries, and (d) dark areas 510d at grazing angles, where the projection brightness falls off sharply. Issues (a)-(d) combine to create a non-uniform appearance, breaking the illusion of seamless projected imagery. Image 502a shows a base map after processing with the blend map calculation and shadow-expansion compensation according to the disclosed techniques. The resulting grayscale base map appears evenly illuminated, with smooth tonal transitions across the surface, regardless of geometry, projector overlap, or viewing angle. Image 502b demonstrates the same surface with projected media after compensation. The defects seen in 501b are no longer present: (a) the hotspot 510a in the center has been eliminated, (b) hard coverage edges 510b are blended smoothly, (c) cast shadow transitions 510c are softened, and (d) brightness at dark areas 510d is corrected to maintain visual consistency. The processed result in image 502b results in a uniform and artifact-free projection surface, enabling projected media 307 to appear natural and integrated with the 3D surface geometry.

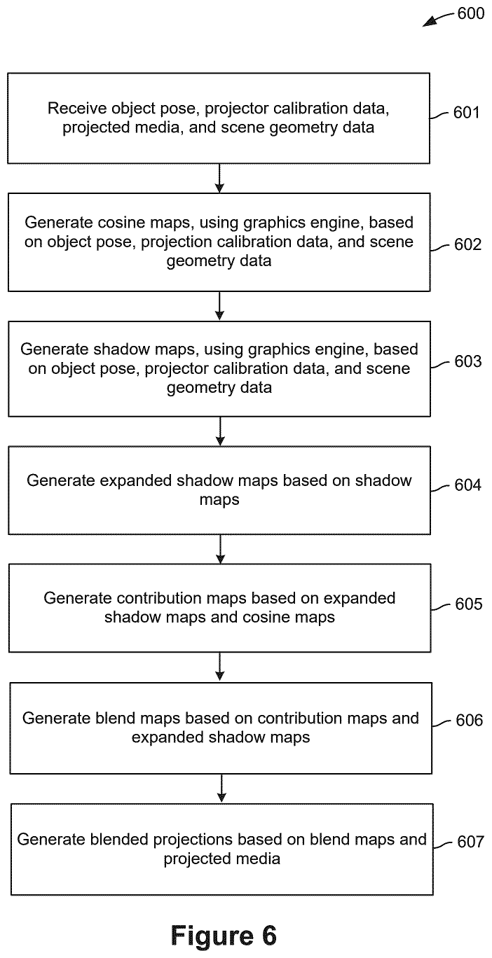

FIG. 6 is a flow diagram of method steps for generating blended projections 302, according to various embodiments. Although the method steps are described in conjunction with the systems of FIGS. 1-5, persons skilled in the art will understand that any system configured to perform the method steps in any order falls within the scope of the present disclosure.

As shown, a method 600 begins with step 601, where projection application 145 receives object pose 301, projector calibration data 121, projected media 307, and scene geometry data 122. Projector calibration data 121 includes intrinsic parameters of each projector 161, such as focal length, principal point, lens distortion coefficients, resolution, and pixel aspect ratio, as well as extrinsic parameters, such as the position and orientation of each projector 161 relative to a world coordinate system or object 162 being projected upon. Projector calibration data 121 further includes per-pixel warp or correction maps to account for optical distortions or misalignments, as well as timing parameters for synchronization with other projectors 161. Scene geometry data 122 includes the spatial arrangement, scale, and shape descriptors of object 162 and the surrounding environment included in scene 160, such as vertex coordinates, polygon connectivity, point cloud data, and/or the like. Scene geometry data 122 also includes surface normals, material reflectance properties, and other attributes that assist in simulating light interaction and occlusion. In some embodiments, scene geometry data 122 is dynamically updated to reflect real-time changes in the position, orientation, or deformation of object 162. In some embodiments, scene geometry data 122 includes a 3D representation of object 162 or environment included in scene 160 to be projected upon, which can be expressed as a polygon mesh, point cloud, or other surface parametrization, such as a UV surface representation. Projected media 307 includes one or more input images, video frames, or other graphical content to be displayed on the projection surface of object 162. For each projector 161, projection application 145 applies the corresponding blend map, which encodes per-pixel intensity adjustments calculated to achieve uniform perceived brightness across the projection surface of object 162.

At step 602, cosine map generator 147 generates cosine maps 303, using graphics engine 146, based on object pose 301, projector calibration data 121, and scene geometry data 122. In some embodiments, cosine map generator 147 uses Lambert's Cosine Law to generate cosine maps 303. In some embodiments, cosine map generator 147 generates cosine compensation maps (e.g., cosine maps 303) that counteract the brightness variation to achieve uniform illumination across the projection surface of object 162. In some embodiments, cosine map generator 147 uses a custom shader included in graphics engine 146 that outputs, for each projector 161, a value between 0 and 1 of the cosine light value included in cosine maps 303 from the projector 161. The cosine light values are written out to a unique channel, for example, red and green, respectively. In some examples, the custom shader renders the image in UV space, which requires scene 160 or a model of scene 160 to have properly defined UVs with minimal seams and no overlaps. In some embodiments, cosine map generator 147 generates cosine maps 303 using graphics engine 146 that renders the 3D scene geometry included in scene geometry data 122 from the perspective of each projector 161, with each projector 161 represented as a light source. In some embodiments, graphics engine 146 uses a basic Lambertian shading material with diffuse color set to pure white (1,1,1), resulting in a rendered image in which each pixel encodes the cosine light value included in cosine maps 303 for the corresponding surface point of object 162. The rendered image is then inverted (1/x) to generate cosine compensation maps that cancel the cosine effect. In some embodiments, cosine map generator 147 uses a custom shader that directly outputs the inverse cosine light values (e.g., cosine maps 303) in a single rendering pass, thereby avoiding the need for multiple passes and improving computational efficiency. In some embodiments, cosine map generator 147 generates cosine maps 303 in UV space, enabling a single set of lighting and shadow computations to be reused for N projectors 161, rather than performing N×N per-view computations. In some embodiments where UV space representation is unavailable, cosine map generator 147 uses a “neutral” view space to provide cosine light values for all projectors 161 from a single reference viewpoint, followed by reprojection into individual view spaces of projectors 161. In some embodiments, cosine map generator 147 uses any shared common space upon which lighting and shadow computations can be performed consistently for all projectors 161. In some embodiments, the shared common space includes, without limitation, a UV coordinate space, a neutral view space, or another representation that enables reuse of a single set of lighting computations across projectors 161. The shared common space provides a unified domain in which cosine light values can be generated once and then distributed or reprojected into the respective projector view spaces, thereby improving computational efficiency.

At step 603, shadow map generator 148 generates shadow maps 304, using graphics engine 146, based on object pose 301, projector calibration data 121, and scene geometry data 122. In some embodiments, shadow maps 304 include a binary value of 0 or 1 for every pixel per projector 161. In some embodiments, each shadow map 304 includes occlusion information in a depth-buffer format or equivalent representation, where pixels corresponding to visible points store a value indicating direct illumination, and pixels corresponding to occluded points store a value indicating shadow. In some embodiments, shadow map generator 148 uses the same rendering pass as cosine map generator 147, outputting the hard shadow map values included in shadow maps 304 to a separate channel (e.g., green or red). In some embodiments, shadow map generator 148 uses graphics engine 146 to render scene 160 from the perspective of each projector 161 using depth rendering techniques to capture the distance from each projector 161 to the nearest visible surface point of object 162, generating depth data. During subsequent shading or blending computations, a given surface point is compared against the depth data to determine whether the point lies in a direct line of sight of each projector 161 or falls within an occlusion region in order to generate a shadow map 304. The resulting shadow map 304 can be stored in a floating-point or integer texture format to allow high-resolution shadow determination for intricate geometry of object 162. In some embodiments, shadow map generator 148 operates in UV space to generate shadow maps 304 for all projectors 161 from a single precomputed geometric representation, reducing computational load by avoiding redundant per-view passes. In some embodiments where a UV space representation of object 162 is not available, shadow map generator 148 uses a neutral view space to generate shadow information included in shadow maps 304, followed by reprojection into individual spaces of projectors 161. In some embodiments, shadow map generator 148 uses any shared common space upon which shadow computations can be performed consistently for all projectors 161. The shared common space includes, without limitation, a UV coordinate space, a neutral view space, or another representation that enables generation of shadow values once and subsequent reprojection into the view space of each projector 161.

At step 604, shadow expansion module 149 generates expanded shadow maps 305 based on shadow maps 304. In some embodiments, shadow expansion module 149 isolates shadow values included in shadow maps 304 and applies a sequence of image processing operations, such as dilation and blurring, to increase the spatial extent of shadow regions while maintaining smooth transitions at the boundaries. In some embodiments, shadow expansion module 149 performs the expansion in UV space permitting that the operation occurs in a 2D parameterization of the surface of object 162, where the expansion follows surface topology without introducing discontinuities. In UV-based processing, shadow expansion module 149 enlarges shadow regions uniformly, generating expanded shadow areas with soft, feathered edges that facilitate realistic blending when multiple projectors 161 illuminate overlapping areas of the projection surface of object 162.

At step 605, projection contribution calculator 150 generates contribution maps 306 based on expanded shadow maps 305 and cosine maps 303. In some embodiments, projection contribution calculator 150 uses expanded shadow maps 305 to attenuate or nullify cosine light values included in cosine maps 303 in pixels that are shadowed relative to a given projector 161. For each pixel, projection contribution calculator 150 calculates an illumination mask as 1−sᵢ, where sᵢ is the corresponding value from the expanded shadow map 305 for projector 161 i (e.g., 0=fully illuminated, 1=fully shadowed). Projection contribution calculator 150 then multiplies the cosine light values by the illumination mask to generate an unshadowed cosine light value pᵢ for every pixel. The masking ensures that regions occluded from the light of a projector 161 do not contribute to the brightness calculation. In some embodiments, projection contribution calculator 150 uses an equal distribution adjustment function, for example, as expressed in Equation 2A. In some embodiments, projection contribution calculator 150 applies an unequal prioritized distribution, for example, as given by Equation 2B. In some embodiments, projection contribution calculator 150 uses any adjustment function, which fulfills the requirement given by Equation 1. In some embodiments, projection contribution calculator 150 further applies value-based feathering between unshadowed contributions (e.g., unshadowed cosine light values) from various projectors 161 to smooth transitions where the dominant projector 161 changes. For example, projection contribution calculator 150 can use basic linear feathering between two unshadowed projectors 161 p₀ and p₁ as given by Equation 3.

At step 606, blend map calculator 151 generates blend maps based on contribution maps 306 and expanded shadow maps 305. In some embodiments, blend map calculator 151 applies a blurring operation to light value components included in contribution maps 306 to mitigate the effects of real-world imperfections and misalignments, while maintaining sharpness in shadow components included in shadow maps 305. In some embodiments, blend map calculator 151 multiplies the light value components by the preserved shadow values to generate blend maps.

At step 607, projection application 145 generates blended projections 302 based on blend maps and projected media 307. In some embodiments, for each projector 161, projection application 145 applies the corresponding blend map, which encodes per-pixel intensity adjustments calculated to achieve uniform perceived brightness across the projection surface of object 162. In some embodiments, projection application 145 multiplies the blend maps with the pixel values of the projected media 307 in the image space of each projector 161 (e.g., UV space or projector-specific view space), attenuating regions that require brightness reduction and maintaining or amplifying regions that require compensation for incident angle effects or multi-projector overlap. Projection application 145 then transmits the adjusted per-projector images included in blended projections 302 to projectors 161 for synchronous output, in which each of projectors 161 projects light based on one of the adjusted per-projector images. When projected simultaneously, the combined output from all projectors 161 generates a uniformly illuminated blended projection 302 on the surface of object 162, with compensated brightness in overlap regions, corrected for incident angle variations, and masked for occluded areas. In some embodiments, the steps 602-607 are implemented as shader passes executed on a GPU. By leveraging the GPU rendering, the disclosed techniques can be performed at interactive frame rates, thereby allowing blend maps and blended projections 302 to be dynamically updated in response to real-time changes in scene 160.

In sum, techniques are disclosed for projection mapping using dynamic blend maps. In some embodiments, a projection application interacts with a graphics engine to process an object pose, projector calibration data, and scene geometry data and generate one or more blended projections. The graphics engine uses an object surface model, such as a UV surface representation, to render a scene with one or more projectors being represented by virtual light source(s). The projection application includes, without limitation, a cosine map generator, a shadow map generator, a shadow expansion module, a projection contribution calculator, and a blend map calculator. The cosine map generator generates one or more cosine maps based on the rendering of the scene. The shadow map generator uses the graphics engine to process an object pose, project calibration data, and scene geometry data via a shadow mapping technique and generates one or more shadow maps. The shadow expansion module processes the shadow maps and generates one or more expanded shadow maps, such as using morphological dilation, Gaussian feathering, or other smoothing operations. The projection contribution calculator processes the cosine maps and the expanded shadow maps and generates one or more contribution maps, which represent per-pixel weighting factors indicating the relative influence of each projector in regions of overlap. The blend map calculator processes the expanded shadow maps and the contribution maps and generates one or more blend maps, which are grayscale images in which each pixel encodes a brightness multiplier to be applied to the projection content prior to output. The projection application then multiplies the blend maps and projected media to generate the blended projections. One or more projectors can apply the blended projections to an object in the scene.

At least one technical advantage of the disclosed techniques relative to the prior art is that the disclosed techniques dynamically calculate blend maps and apply the blend maps to projected content in real time based on continuously updated scene information. Unlike conventional approaches that are static, the disclosed techniques recalculate per-projector contribution maps using live geometric, shadow, and lighting data from the projection surface of the object. As the scene changes, such as when an object moves, deforms, or experiences varying illumination, the expanded shadow maps, cosine maps, projector contributions, and resulting blend maps are regenerated to reflect the new conditions. The regenerations can be executed as shader passes on a graphics processing unit (GPU), which enables interactive frame rates in real time, which enables the projection to maintain accurate brightness compensation between projectors, and correct shadow handling even during motion or interaction These technical advantages represent one or more technological improvements over prior art approaches.

1. In some embodiments, a computer-implemented method for projecting light comprises generating, based on a pose of an object within the scene, projector calibration data associated with one or more projectors, and scene geometry data associated with the scene, one or more blend maps using a graphics engine, generating, based on the one or more blend maps and media to be projected via the one or more projectors, one or more blended projections, and causing the one or more projectors to project light upon the object based on the one or more blended projections.

2. The computer-implemented method of clause 1, wherein generating the one or more blend maps comprises generating, based on the pose of the object, the projector calibration data, and the scene geometry data, one or more cosine maps and one or more shadow maps, generating, based on the one or more shadow maps, one or more expanded shadow maps, generating, based on the one or more expanded shadow maps and the one or more cosine maps, one or more contribution maps, and generating, based on the one or more expanded shadow maps and the one or more contribution maps, the one or more blend maps.

3. The computer-implemented method of clauses 1 or 2, wherein at least one of generating the one or more cosine maps, generating the one or more shadow maps, generating the one or more contribution maps, or generating the one or more expanded shadow maps is performed using one or more shader passes executed via the graphics engine.

4. The computer-implemented method of any of clauses 1-3, wherein the one or more cosine maps and the one or more shadow maps are generated in a shared common space and reuse a single set of lighting computations and a single set of shadow computations for the one or more projectors.

5. The computer-implemented method of any of clauses 1-4, wherein the shared common space comprises at least one of a UV space or a neutral view space.

6. The computer-implemented method of any of clauses 1-5, wherein the one or more cosine maps are generated by using a shared common space to provide one or more cosine light values included in the one or more cosine maps from a single reference viewpoint.

7. The computer-implemented method of any of clauses 1-6, wherein generating the expanded shadow maps comprises applying at least one of a dilation or a blurring operation to increase one or more shadow regions included in the one or more shadow maps and to generate one or more transitions at one or more boundaries included in the one or more shadow maps.

8. The computer-implemented method of any of clauses 1-7, wherein generating the one or more contribution maps comprises calculating, based on the one or more expanded shadow maps, one or more illumination masks, and multiplying the one or more illumination masks with one or more cosine light values included in the one or more cosine maps to generate one or more unshadowed cosine light values.

9. The computer-implemented method of any of clauses 1-8, wherein generating the one or more blended projections comprises multiplying the one or more blend maps with one or more pixel values included in the media to be projected in a first image space of a first projector included in the one or more projectors to generate a first blended projection included in the one or more blended projections.

10. The computer-implemented method of any of clauses 1-9, further comprising, in response to determining that a real-time change has occurred in the scene, dynamically updating the one or more blend maps and the one or more blended projections.

11. In some embodiments, one or more non-transitory computer-readable media store instructions that, when executed by one or more processors, cause the one or more processors to perform the steps of generating, based on a pose of an object within a scene, projector calibration data associated with one or more projectors, and scene geometry data associated with the scene, one or more blend maps using a graphics engine, generating, based on the one or more blend maps and media to be projected via the one or more projectors, one or more blended projections, and causing the one or more projectors to project light upon the object based on the one or more blended projections.

12. The one or more non-transitory computer-readable media of clause 11, wherein generating the one or more blend maps comprises generating, based on the pose of the object, the projector calibration data, and the scene geometry data, one or more cosine maps and one or more shadow maps, generating, based on the one or more shadow maps, one or more expanded shadow maps, generating, based on the one or more expanded shadow maps and the one or more cosine maps, one or more contribution maps, and generating, based on the one or more expanded shadow maps and the one or more contribution maps, the one or more blend maps.

13. The one or more non-transitory computer-readable media of clauses 11 or 12, wherein at least one of generating the one or more cosine maps, generating the one or more shadow maps, generating the one or more contribution maps, or generating the one or more expanded shadow maps is performed using one or more shader passes executed via the graphics engine.

14. The one or more non-transitory computer-readable media of any of clauses 11-13, wherein the one or more cosine maps and the one or more shadow maps are generated in a shared common space and reuse a single set of lighting computations and a single set of shadow computations for the one or more projectors.

15. The one or more non-transitory computer-readable media of any of clauses 11-14, wherein the shared common space comprises at least one of a UV space or a neutral view space.

16. The one or more non-transitory computer-readable media of any of clauses 11-15, wherein generating the one or more blend maps comprises multiplying one or more light value components included in the one or more contribution maps with one or more preserved shadow values included in the one or more expanded shadow maps to generate the one or more blend maps.

17. The one or more non-transitory computer-readable media of any of clauses 11-16, wherein generating the one or more contribution maps comprises calculating, based on the one or more expanded shadow maps, one or more illumination masks, and multiplying the one or more illumination masks with one or more cosine light values included in the one or more cosine maps to generate one or more unshadowed cosine light values.

18. The one or more non-transitory computer-readable media of any of clauses 11-17, wherein the instructions, when executed by the one or more processors, further cause the one or more processors to perform the steps of calculating, based on the one or more unshadowed cosine light values, at least one of an equal distribution adjustment function, an unequal prioritized distribution function, or an adjustment function that is between the equal distribution adjustment function and the unequal prioritized distribution function.

19. The one or more non-transitory computer-readable media of any of clauses 11-18, wherein the instructions, when executed by the one or more processors, further cause the one or more processors to perform the step of in response to determining that a real-time change has occurred in the scene, dynamically updating the one or more blend maps and the one or more blended projections.

20. In some embodiments, a system comprises one or more memories storing instructions, and one or more processors that are coupled to the one or more memories and, when executing the instructions, are configured to generate, based on a pose of an object within a scene, projector calibration data associated with one or more projectors, and scene geometry data associated with the scene, one or more blend maps using a graphics engine, generate, based on the one or more blend maps and media to be projected via the one or more projectors, one or more blended projections, and cause the one or more projectors to project light upon the object based on the one or more blended projections.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for projecting light, the method comprising:
generating, based on a pose of an object within the scene, projector calibration data associated with one or more projectors, and scene geometry data associated with the scene, one or more blend maps using a graphics engine;
generating, based on the one or more blend maps and media to be projected via the one or more projectors, one or more blended projections; and
causing the one or more projectors to project light upon the object based on the one or more blended projections.

2. The computer-implemented method of claim 1, wherein generating the one or more blend maps comprises:
generating, based on the pose of the object, the projector calibration data, and the scene geometry data, one or more cosine maps and one or more shadow maps;
generating, based on the one or more shadow maps, one or more expanded shadow maps;
generating, based on the one or more expanded shadow maps and the one or more cosine maps, one or more contribution maps; and
generating, based on the one or more expanded shadow maps and the one or more contribution maps, the one or more blend maps.

3. The computer-implemented method of claim 2, wherein at least one of generating the one or more cosine maps, generating the one or more shadow maps, generating the one or more contribution maps, or generating the one or more expanded shadow maps is performed using one or more shader passes executed via the graphics engine.

4. The computer-implemented method of claim 2, wherein the one or more cosine maps and the one or more shadow maps are generated in a shared common space and reuse a single set of lighting computations and a single set of shadow computations for the one or more projectors.

5. The computer-implemented method of claim 4, wherein the shared common space comprises at least one of a UV space or a neutral view space.

6. The computer-implemented method of claim 2, wherein the one or more cosine maps are generated by using a shared common space to provide one or more cosine light values included in the one or more cosine maps from a single reference viewpoint.

7. The computer-implemented method of claim 2, wherein generating the expanded shadow maps comprises applying at least one of a dilation or a blurring operation to increase one or more shadow regions included in the one or more shadow maps and to generate one or more transitions at one or more boundaries included in the one or more shadow maps.

8. The computer-implemented method of claim 2, wherein generating the one or more contribution maps comprises:
calculating, based on the one or more expanded shadow maps, one or more illumination masks; and
multiplying the one or more illumination masks with one or more cosine light values included in the one or more cosine maps to generate one or more unshadowed cosine light values.

9. The computer-implemented method of claim 1, wherein generating the one or more blended projections comprises multiplying the one or more blend maps with one or more pixel values included in the media to be projected in a first image space of a first projector included in the one or more projectors to generate a first blended projection included in the one or more blended projections.

10. The computer-implemented method of claim 1, further comprising, in response to determining that a real-time change has occurred in the scene, dynamically updating the one or more blend maps and the one or more blended projections.

11. One or more non-transitory computer-readable media storing instructions that, when executed by one or more processors, cause the one or more processors to perform the steps of:
generating, based on a pose of an object within a scene, projector calibration data associated with one or more projectors, and scene geometry data associated with the scene, one or more blend maps using a graphics engine;
generating, based on the one or more blend maps and media to be projected via the one or more projectors, one or more blended projections; and
causing the one or more projectors to project light upon the object based on the one or more blended projections.

12. The one or more non-transitory computer-readable media of claim 11, wherein generating the one or more blend maps comprises:
generating, based on the pose of the object, the projector calibration data, and the scene geometry data, one or more cosine maps and one or more shadow maps;
generating, based on the one or more shadow maps, one or more expanded shadow maps;
generating, based on the one or more expanded shadow maps and the one or more cosine maps, one or more contribution maps; and
generating, based on the one or more expanded shadow maps and the one or more contribution maps, the one or more blend maps.

13. The one or more non-transitory computer-readable media of claim 12, wherein at least one of generating the one or more cosine maps, generating the one or more shadow maps, generating the one or more contribution maps, or generating the one or more expanded shadow maps is performed using one or more shader passes executed via the graphics engine.

14. The one or more non-transitory computer-readable media of claim 12, wherein the one or more cosine maps and the one or more shadow maps are generated in a shared common space and reuse a single set of lighting computations and a single set of shadow computations for the one or more projectors.

15. The one or more non-transitory computer-readable media of claim 14, wherein the shared common space comprises at least one of a UV space or a neutral view space.

16. The one or more non-transitory computer-readable media of claim 12, wherein generating the one or more blend maps comprises multiplying one or more light value components included in the one or more contribution maps with one or more preserved shadow values included in the one or more expanded shadow maps to generate the one or more blend maps.

17. The one or more non-transitory computer-readable media of claim 12, wherein generating the one or more contribution maps comprises:
calculating, based on the one or more expanded shadow maps, one or more illumination masks; and
multiplying the one or more illumination masks with one or more cosine light values included in the one or more cosine maps to generate one or more unshadowed cosine light values.

18. The one or more non-transitory computer-readable media of claim 17, wherein the instructions, when executed by the one or more processors, further cause the one or more processors to perform the steps of calculating, based on the one or more unshadowed cosine light values, at least one of:
an equal distribution adjustment function;
an unequal prioritized distribution function; or
an adjustment function that is between the equal distribution adjustment function and the unequal prioritized distribution function.

19. The one or more non-transitory computer-readable media of claim 11, wherein the instructions, when executed by the one or more processors, further cause the one or more processors to perform the step of in response to determining that a real-time change has occurred in the scene, dynamically updating the one or more blend maps and the one or more blended projections.

20. A system, comprising:
one or more memories storing instructions, and
one or more processors that are coupled to the one or more memories and, when executing the instructions, are configured to:
generate, based on a pose of an object within a scene, projector calibration data associated with one or more projectors, and scene geometry data associated with the scene, one or more blend maps using a graphics engine,
generate, based on the one or more blend maps and media to be projected via the one or more projectors, one or more blended projections, and
cause the one or more projectors to project light upon the object based on the one or more blended projections.
